(19) United States
(12) Patent Application Publication
(10) Pub. No.: US 2009/0037292 A1
(43) Pub. Date: Feb. 5, 2009

(54) Intelligent shopping search system

(75) Inventor: Dileep Kumar Panjwani, San Jose, CA (US)

Correspondence Address: Dileep Kumar Panjwani, 3266 Capriana Circle, San Jose, CA, 95135, US

(73) Assignee: Neo Notion, Inc, San Jose, CA (US)

(21) Appl. No.: 11/881,859

(22) Filed: Jul. 30, 2007

(51) Int. Cl. G06Q 30/00

(52) U.S. Cl. 705/27

(57) ABSTRACT

This invention provides a method of building an intelligent electronic shopping search system that helps a customer search and shop items which have the best match for him/her using a programmed computer, CD-ROM, television, Internet or other electronic medium such as video. The method comprises receiving personal information including body characteristics, personal preferences and style from the customer; making the customer selects the item he wants to shop or search; using expert and fashion knowledge rules which contain information of what works best for people along with his personal preferences to find the items in the descending order of their personal scores for the customer; and presenting the shopping search items to the customer in the descending order of their personal scores, such that the items with higher personal score come before the items with lower scores.

### BACKGROUND OF THE INVENTION

This invention relates to electronic shopping search systems, and more particularly, to intelligent shopping search systems that help a customer search and shop items which have the highest utility for him/her using a programmed computer, CD-ROM, television, Internet or other electronic medium such as video.

Electronic shopping search systems have been developed and deployed since the emergence of Internet in early nineties. In the early says of the Internet, the shopping search system allowed customers to search for items using keywords, and permitted price comparison of offers from various merchants for an item. The Internet websites, http://www.froogle.com, http://shopping.yahoo.com, and http://www.pricegrabber.com are good examples of such shopping search systems. Over the years, these systems have advanced and allowed user to search for items by combination of keyword, price, discount, various product attributes, and customer ratings. The websites, http://www.amazon.com and http://www.shopzilla.com are good examples of such shopping search systems.

Most of these shopping systems have lacked intelligence to optimize their search results by understanding what will work best for consumers and what they like or dislike. One of personalization that today's shopping search systems such as. http://www.amazon.com do well is collaborative filtering (U.S. Pat. No. 6,064,980). Collaborative filtering systems operate generally by creating users' profile. To identify the items that may be of interest to a particular user, the service correlates the user's profile to the profiles of other users to identify users with similar tastes.

Recently a shopping search system http://www.zafu.com was launched for shopping Women Jeans. This search system receives information from women customers regarding their body characteristics and finds what brand of jeans will work well for them.

One of obstacle to growth of Internet retailing is the inability of customers to try and see the items before their purchases. Many customers are averse to buying items without knowing the items are right for them. This is the reason that the percentage of Internet sales for non technical products is less than 2% of the total sales of such items. It is also the reason for high return rate for items purchased on the Internet.

It is therefore an object of the present invention to provide an intelligent and personalized electronic shopping search system that helps a customer search and shop items which have the highest utility for the customer, reducing the changes of mismatch and increasing the satisfaction for customer.

### SUMMARY AND OBJECTS OF THE INVENTION

An intelligent Internet shopping search systems is provided that helps a customer search and shop items which have the match for him/her using a programmed computer, CD-ROM, television, Internet or other electronic medium. To attain this, the method comprises receiving personal information including body characteristics, personal preferences and style from the customer; making the customer selects the item he wants to shop or search; using expert and fashion knowledge rules which contain information of what works best for people along with his personal preferences to find the items in the descending order of their personal scores for the customer; and presenting the shopping search items to the customer in the descending order of their personal scores, such that the items with higher personal score come before the items with lower scores.

Accordingly, it is an object of the present invention to provide a method of electronic shopping that enables a search engine, which provides access to products from many merchants, to provide a value added service by helping customers find their best match to improve their satisfaction and simplify the search and selection process.

Another object of the present invention is to provide a method of electronic shopping as a marketing and sales tool for online retailers to provide enhanced services and make it easy to shop.

Still another object of the present invention is to provide a method of electronic shopping which gives retailers, shopping hubs (a website which provides access to multiple merchants), and search engines the opportunity to build customer loyalty and provide outstanding personal service.

Yet another object of the present invention is to furnish a method of electronic shopping that reduces returns due to improper fit of the merchandise.

A further object of the present invention is to provide a method of electronic shopping to reduce the amount of time spent in shopping.

Another object of the present invention is to provide an intelligent personalized system that helps women, men, and children save time, money, and countless hours of frustration by helping them find fashion items which look good on them, items which cater to their personality and lifestyle, addresses their personal preferences, maximizes the benefits, and minimizes the negative effects of the merchandize being purchased.

These and still further objects will become apparent hereinafter. These and other features of the present invention are described in more detail in the following detailed description when taken with the drawings. The scope of the invention, however, is limited only by the claims appended hereto.

### BRIEF DESCRIPTION OF THE DRAWINGS

FIG. 1 is a flowchart illustrating the method for intelligent and personalized search for shopping items.

FIG. 2 illustrates how a customer can select the item he/she wants to shop.

FIG. 3 shows various elements of personal information for women shoppers.

FIG. 4 shows various elements of personal information for men shoppers.

FIG. 5 shows various elements of personal information for kid shoppers.

FIG. 6 displays various components of the knowledge store used to evaluate the personal score for customers.

FIG. 7 shows how the personal score is evaluated for shopping items.

FIG. 8 illustrates the flowchart of the method to retrieve the shopping items in the descending order of personal score,

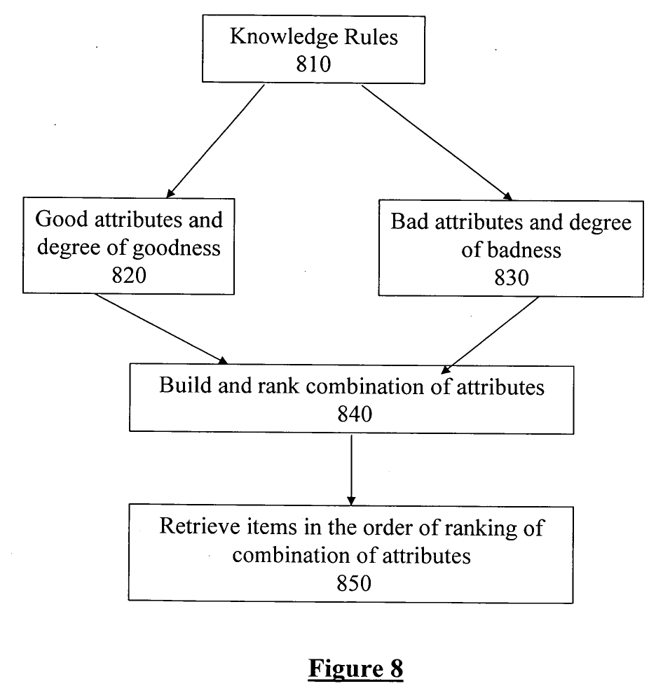

FIG. 9 illustrates how the intelligent shopping system presents the items to the customer sorted by his personal scores.

FIG. 10 shows a sample of the shopping item personal analysis presented to the customer.

FIG. 11 illustrates how the system can continuous learn the liked and disliked attributes of a shopping item type for the customer.

FIG. 12 is a flow chart of the method for intelligent and personalized search for shopping items for a customer's friend.

FIG. 13 is a flow chart of the method for electronic shopping systems.

### DETAILED DESCRIPTION OF THE PREFERRED EMBODIMENT

The present invention relates to methods and apparatus for electronic item search and shopping service system by customers employing a computer, the Internet, cell phone, or other electronic medium. This service can be accessed remotely using typical telecommunication systems or any Internet access system. For example, office and home users can connect to it using their Internet access service through analog modems, DSL connections, or wireless connections. The mobile users can access the service using their cell phone Internet service, wireless hot spots, or any other wireless service that enables them to connect their computers, notebooks, or cell phones or any other device to the Internet.

The shopping search system can be used by a merchant to help its customer make decision on what to buy. In that case, the shopping search system will use the inventory of the merchants' products as its database of shopping items. The shopping search system can be used by an electronic shopping hub which gets its product inventory from many merchants. In this case, the shopping search system will incorporate the inventory of all the merchants in its database of shopping items.

When a customer accesses the shopping search service system first time, he needs to provide the personal information about himself to this electronic search system. The customer registers with the service system and provides a personal code that he will use to access his account with the service in the future. The system walks him through a number of screens to get his personal information. The customer's personal information is stored in his account with the search system. When the customer returns to access the system later, he can just login the system using his personal code and start search and shopping. Only first time, the customer provides his personal information. For access to the system in the future, he is not required to provide the personal information, even though he has the option to update his personal information. The system retrieves his personal information using his personal code and uses it for performing shopping item searches.

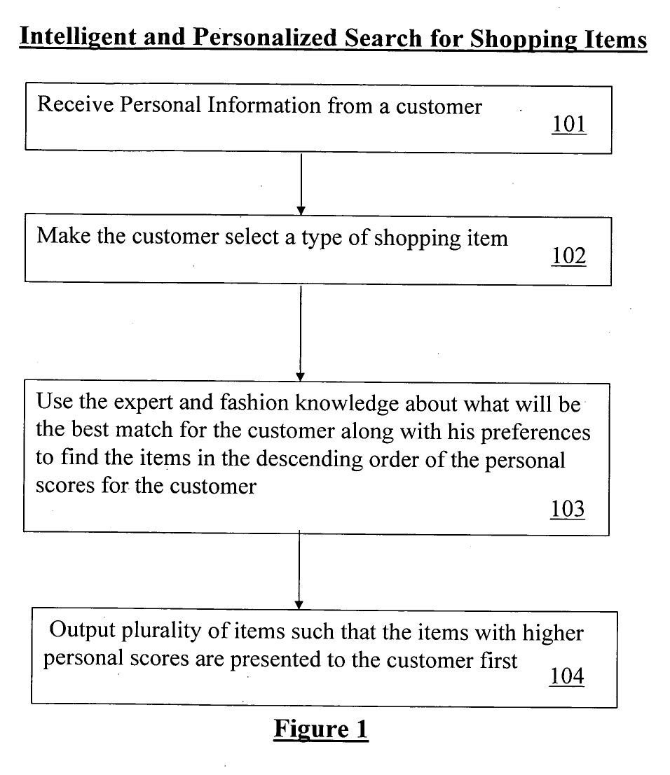

The flowchart for intelligent and personalized shopping search items is illustrated in FIG. 1. It consists of primarily four steps. In the step one (101), the customer provides his personal information to the system. When the customer accesses the shopping search system first time, the system will make the user walk through a number of screens to receive his personal information. When the customer comes back again to access its services, the customer only provides his personal code. The system retrieves his personal information from its database using his personal code. In the second step (102), the customer selects the item he wants to shop or search. In the third step (103), the system uses the expert and fashion knowledge about what will be the best match for the customer along with his preferences to find the items in the descending order of their personal scores. The personal score for a shopping item is the measurement of cumulative utility or level of matching for the customer. The items which have high of utility or level of matching for the customer are given higher scores over the items that have low utility or level of matching for the customer. The personal score also can be considered as the level of satisfaction for the customer. The items with higher personal score will provide more satisfaction than the items with the lower scores. In the step 4 (104), the shopping items are displayed to user in the descending order of their personal scores, such that the items with higher personal score come before the items with lower scores.

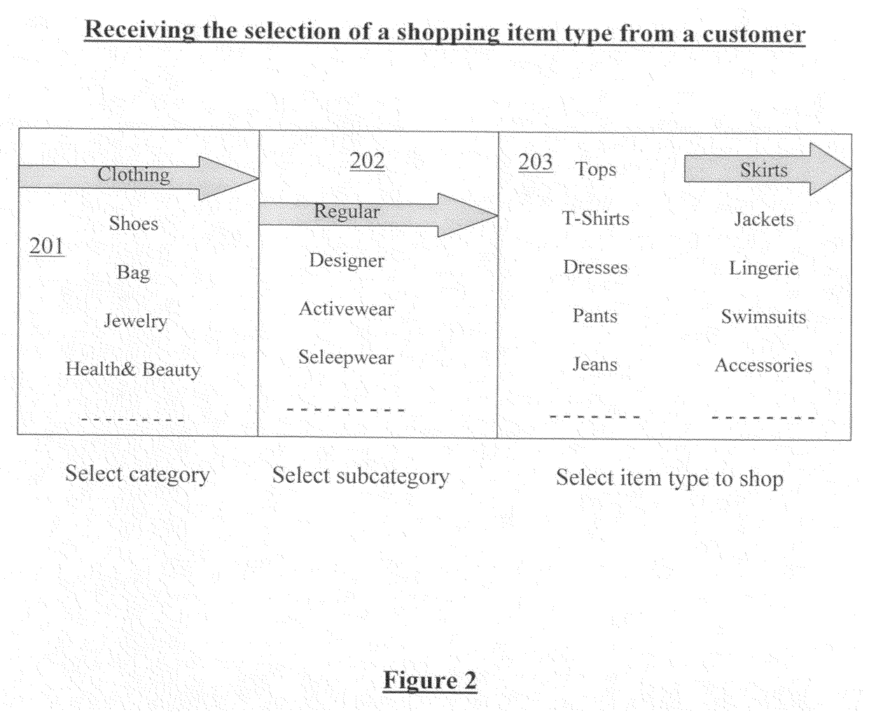

The selection of a shopping type can be a simple selection of an item type from a complete list of items, or it can be a recursive process. The FIG. 2 illustrates the recursive menu screen for selection of an item type. In this approach, user drills down the item categories, departments, subcategories to select an item type. For example, the customer selects category “Clothing” from a list of categories. Then he selects subcategory “Regular” from a list of subcategories. Then he selects the product type “Skirts”. The drill down menu can have as many layers are as are needed to make it easy for customers to select the item type.

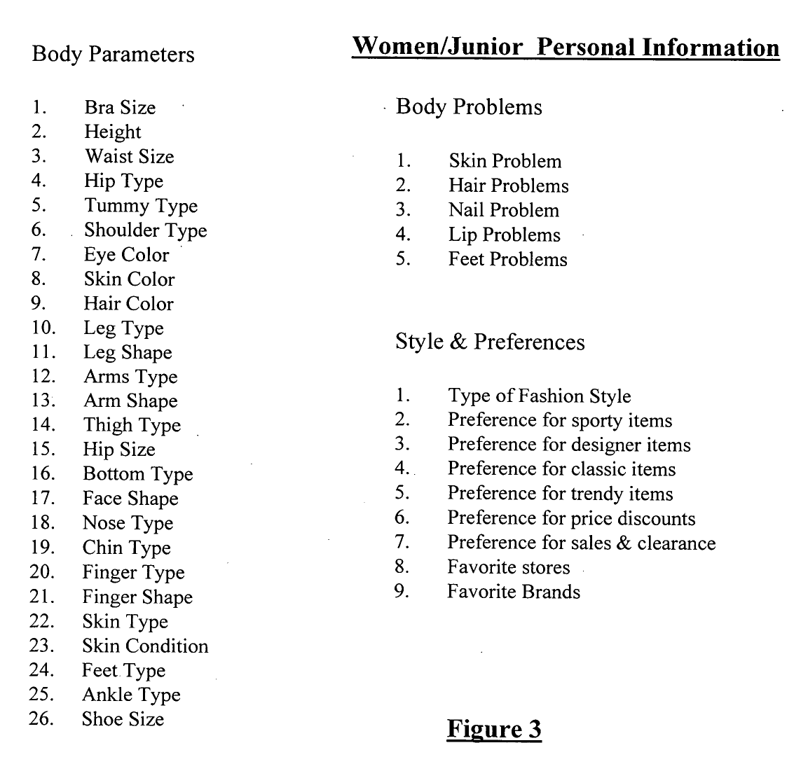

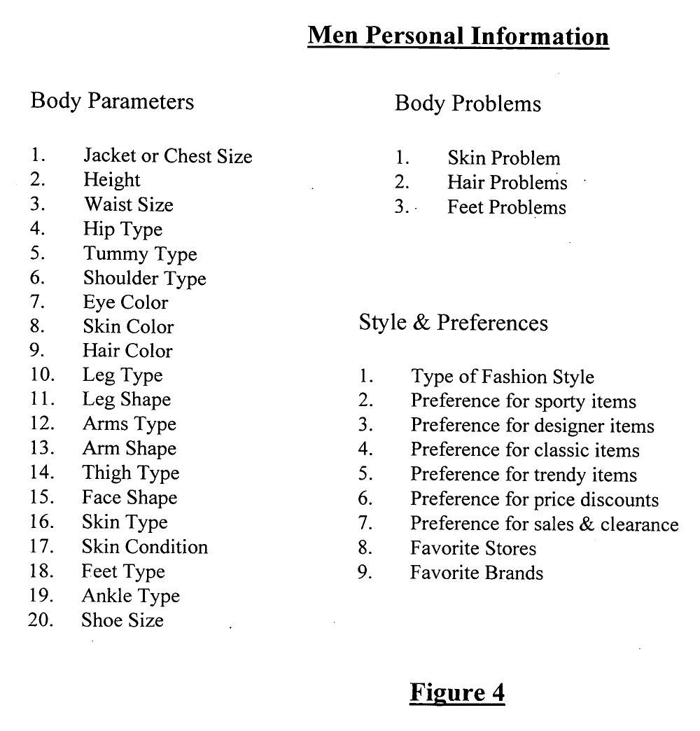

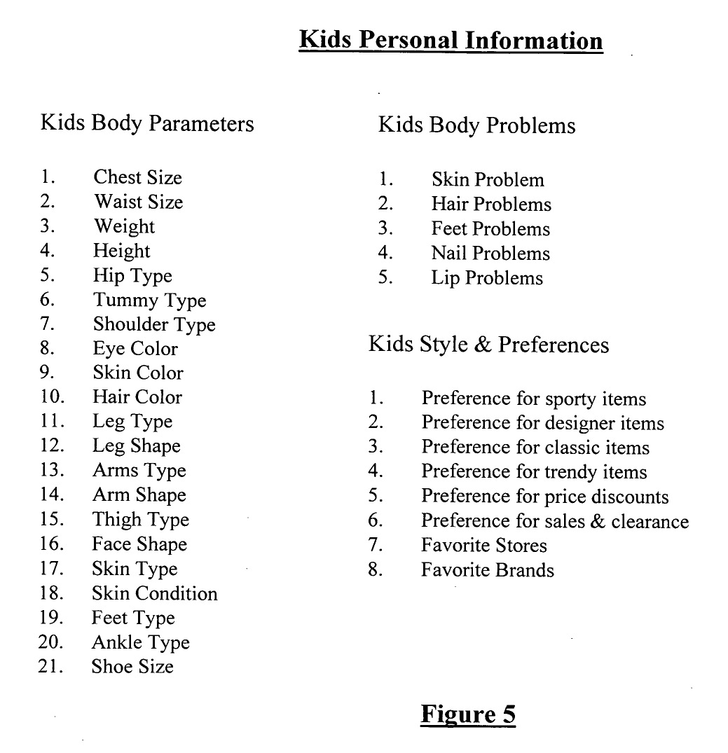

The system applies the fashion and expert knowledge on the customer personal information to figure out what will be the best match for him. The type of personal information that is received from the customer depends on the sex (Male/Female) and age of the person. The customers are divided into nine groups: women (age>20), men (age>16), juniors (females 16<=age<=20), boys (age 5-16), girls(age 5-16), toddler boys(age 2-4), toddler girls(age 2-4), infant boys(age 0-2), and infant Girls(age 0-2). The system receives three types of information: body parameters, body problems, and style & preference parameters. The personal information parameters are same for women and juniors. FIG. 3 shows the sample of personal information that is received from women and junior customers. FIG. 4 shows the sample of personal information that is received from men customers. The personal information parameters are same for all kids: boys, girls, toddles, and infants. FIG. 5 shows the sample of personal information that is received from kids customers. The parameters that are shown in FIGS. 3, 4, and 5 for illustration purpose. These parameters were used to build a system that could support five shopping product categories: clothing, shoes, bags, jewelry, and health & beauty. As more product categories are added and more knowledge is incorporated in the search analysis, these parameters will change.

The system presents a number of screens with questionnaires to the customer to receive his personal information. It is not mandatory to answer every question. It is totally up to the customer what questions he wants to answer. More the information the customer provides the better will be the quality of the shopping search results.

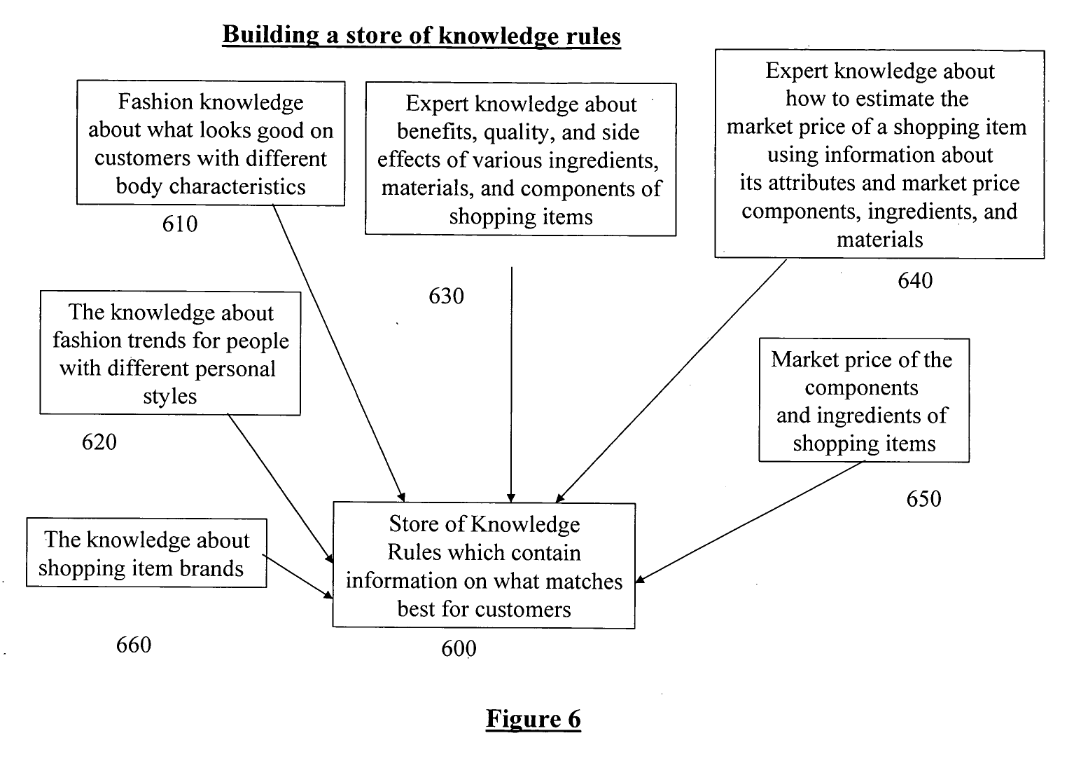

The shopping search system uses fashion and expert knowledge to figure out the best matches for the customer with a given personal profile and preferences. FIG. 6 shows the different types of information elements that are used to build this knowledge store. The knowledge information is broken into rules. There are many common rules which apply to many item types. There are rules which apply only to a specific product type. As illustrated in the FIG. 6, the knowledge store contains the following components:
Fashion knowledge (610) about what looks good from fashion point of view on customers with different body characteristics. One good example of the knowledge rule for this type is that the deeper neckline such as V or U or deep V neckline on tops and dresses look good on women with broad shoulders, while boat neck does not look good. Another example is that the women who are bottom heavy they should wear the tops with details on them, and wear bottoms such skirts and pants without details.
Fashion trend knowledge (620) for people with different personal style. Every year, the fashion designers introduce new designs for fashion items and some of these designs become trends. Not everyone likes the same thing and hence one trend does not work for everyone. People with different personal style like different type of items. For this reason, the knowledge about trends for different personal styles and tastes is included in the knowledge store. This knowledge is used to decide the trendy-ness of an item for a customer of a given personal style. Since the fashion trends change with time and season, these knowledge rules are updated regularly.
Expert knowledge (630) about benefits, technical merits, and side effects of various ingredients, materials, and components of shopping items. One of the good examples of this type of information is the knowledge rules for moisturizers in the health & beauty category. The moisturizer may contain Emollient ingredients which are good for dry skin, but bad for oily skin. So this knowledge can be used to assign high personal score to moisturizers with emollients for customers with dry skin, but low score for customers with oily skin.
Expert knowledge (640) about how to estimate the market price of a shopping item using information about its attributes and market price components, ingredients, and materials.
Market price (650) of the components and ingredients of shopping items. For example, the system uses the price of diamonds, gems, and metal of various qualities and attributes to figure out the market price of a jewelry item. Once the market price of all the components of an item is known, the system can figure out whether the customer is overpaying or underpaying for an item.
Market price (650) of the components and ingredients of shopping items. For example, the system uses the price of diamonds, gems, and metal of various qualities and attributes to figure out the market price of a jewelry item. Once the market price of all the components of an item is known, the system can figure out whether the customer is overpaying or underpaying for an item.
The knowledge (660) about characteristics, performance, and quality of shopping item brands and their styles. Many times the merchant inventory of shopping items does not contain information about all the attributes of a shopping item, but they provide the brand information. The knowledge about brand can help determine the attributes of the item. The quality and performance attribute of a brand can also help determine the personal score of an item for a customer. The brand knowledge rules contain the information about various attributes of a brand, its quality and performance characteristics, and its utility for people with different personal information.
The knowledge about reliability and quality of products based on the tests done by independent and trustworthy authorities and experience of real users into the personal score for items for the customer such that the items with the higher reliability and quality get higher scores

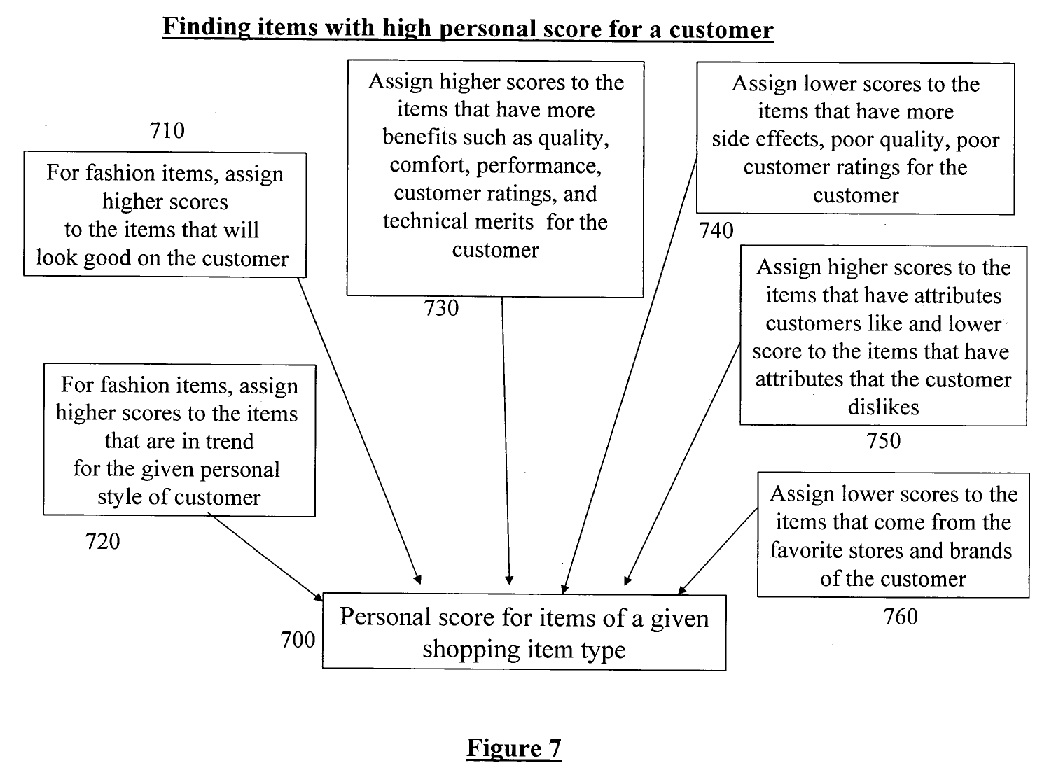

The purpose of knowledge store is to find shopping items in the descending order of their personal scores for the customer. FIG. 7 shows a number of elements that are considered in the evaluation of the personal scores for shopping items. Here is the brief description of these elements:
(710) For fashion items, assign higher scores to the items that will look good on the customer. What will look good on the customer is figured out using the fashion knowledge rules and brand knowledge rules
(720) For fashion items, assign higher scores to the items that are in trend for the given personal style of the customer
(730) Assign higher scores to the items that have more benefits such as quality, comfort, performance, customer ratings, and technical merits for the customer
(740) Assign lower scores to the items that have more side effects, poor quality, poor customer ratings for the customer
(750) Assign higher scores to the items that have attributes customers like and lower score to the items that have attributes that the customer dislikes
(760) Assign lower scores to the items that come from the favorite stores and brands of the customer
Assign higher scores to the items which have the higher reliability and quality ratings by independent and trustworthy authorities

Knowledge store (810) helps in figuring out all the good attributes (820) and their degree of goodness, and all bad attributes (830) and degree of their badness. These attributes are combined to build the ranked combinations of attributes (840) for an item type, such that the highest ranked combinations of attributes will produce the highest personal score. The lowest ranked combinations will produce the lowest personal score. For example, let's say an item has two attributes A1 and A2, where A1 could have values S1, S2, and S3, while A2 could have values T1, T2, and T3. Let's say the knowledge store determines A1=S1 and A2=T2 are very good, A1=S2 and A2=T3 are good, and A1=S3 is very bad and A2=T1 is bad for the customer. The ranked combination of A1, A2 will be as follows:
1. {A1=S1(very good), A2=T2 (very good)},
2. {A1=S1(very good), A2=T3(good)},
3. {A1=S2(good), A2=T2(very good)},
4. {A1=S2(good), A2=T3(good)}
5. {A1=S1(very good), A2=T1(bad)}
6. {A1=S2(good), A2=T1(bad)}
7. {A1=S3(very bad), A2=T2(very good)}
8. {A1=S3(very bad), A2=T3(good)}
9. {A1=S3(very bad), A2=T1(bad)}

In this example, the combination ranked 1 will produce the best personal score and the combination ranked 9 will produce the worst personal scores.

To retrieve the shopping items in the descending order of personal score, the system first finds items with highest ranked combination of attributes and presents to the customers. Next, it goes and finds items with second ranked combination of attributes and presents to the customers. This process is repeated until customer does not want to see the next set of items or all items have been retrieved and presented to the customer.

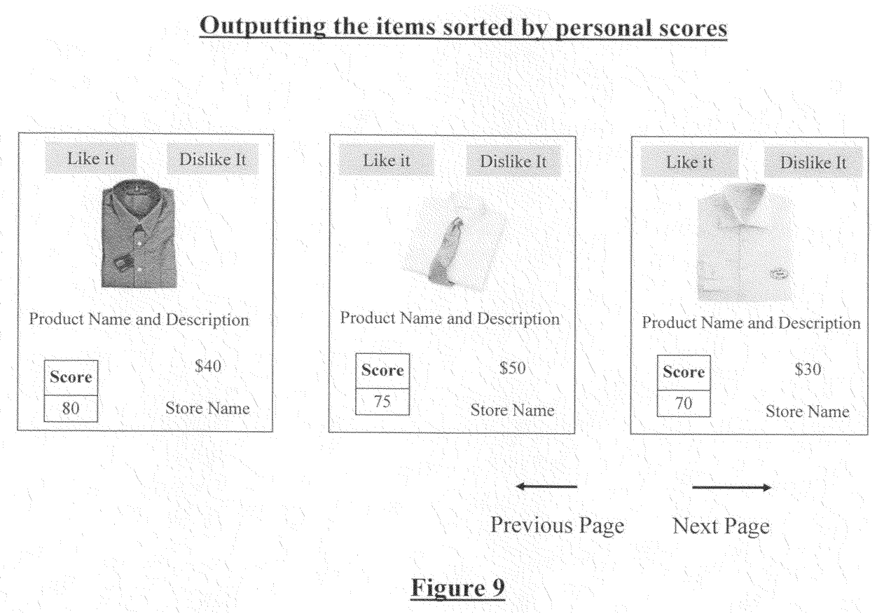

The system retrieves the items from the database using the ranked combination of attributes. The personal score is assigned to every retrieved item and items are put in the list sorted by their personal scores. The items are displayed to user in the descending order of personal score. FIG. 9 provides a sample of how the items can be displayed. The items are divided into pages. Each screen shows one page of the results. User can move from page to another. It is not necessary the layout of the items has to be same as shown in FIG. 9. The layout can be changed and the information displayed can be varied to achieve the same results.

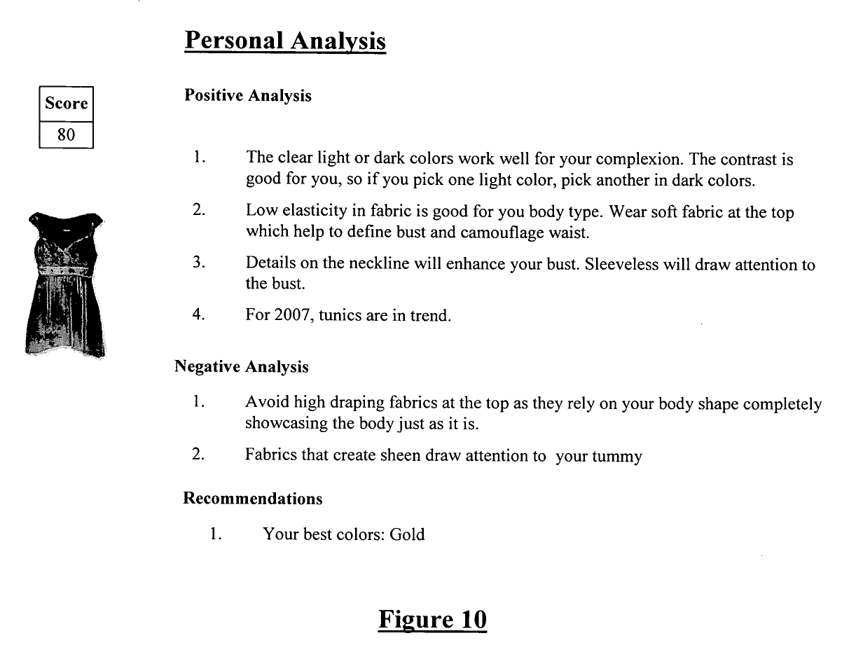

Once user sees the results, he can select any item to see more information about the item. The system also shows the personal score analysis listing all the positive and negative points of the item. FIG. 10 shows an example of the personal analysis. In this example, the analysis of a women top is presented for a customer. The positive analysis provides all the positive point of the select item. The negative analysis also points to negative aspect of the item for the customer. The recommendation section adds additional suggestions. In this case the item may be available in multiple colors. The customer has recommended what colors works best for them.

If it is a merchant who is deploying this system, the system allows user to buy the item by making him walk through the order placement screens. If it is a shopping hub which is using the system, the system will show user all the merchants who are selling the item, and their prices for the selected item. The system can also show the customer ratings and reviews of the shopping item as well as the customer ratings and reviews of various merchants who are selling the item. The system also can show the various promotions being offered by the merchants, which customer can take advantage of if he decided to buy it.

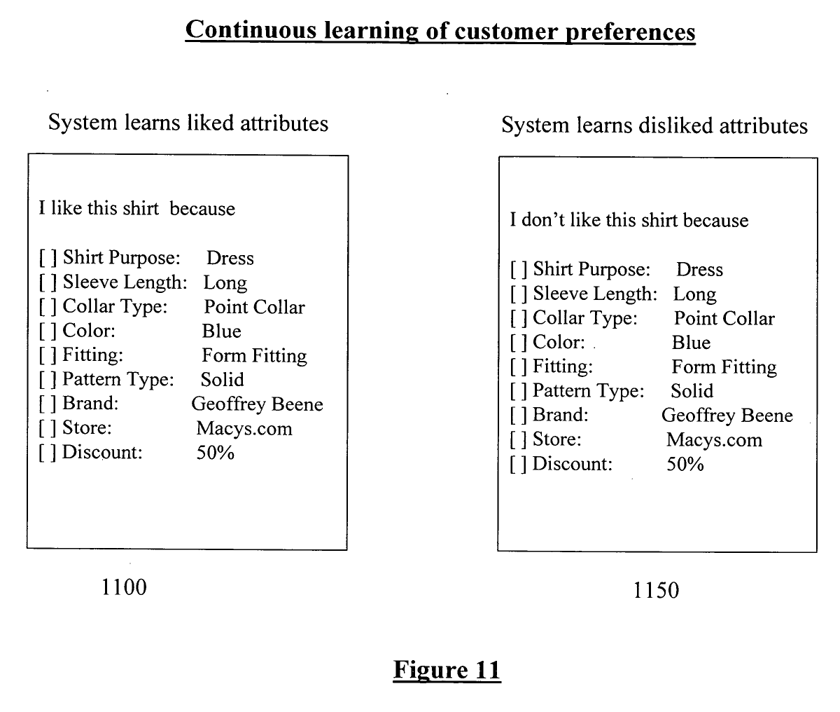

The customer can continuously train the system about his preferences. The customer selects “I like it” or “I dislike it” buttons on a selected shopping search item as illustrated in FIG. 9. If user selects “I like it” option, the user is presented a screen (1100) as shown in FIG. 11. This screen allows user to select multiple attributes that he likes about the item. All these selection are saved in the personal information of the customer as the liked attributes for the selected item-type. For example, the user selects attributes for a shirt on screen (1100). These attributes will be saved as customer's liked attribute for Shirt in his personal information. When the customer shops next time these attributes will become a component of personal score calculations. Similarly, the customer can train the system about his disliked attributes of various item types. The screen (1150) in FIG. 11 shows how he can provide the disliked attributes to the system. These attributes will be saved as customer's disliked attribute for Shirt in his personal information. When the customer shops next time these attributes will become a component of personal score calculations. When item is found with liked attributes, the personal score of the item become higher in proportion to how many liked attributes are present. When an item contains any disliked attribute, its personal score is set to extremely low scores so these items show up at the end of the list.

To summarize this method of continuously learning customer preferences and using them to improve the quality of search results of a shopping search system that helps customers search and shop items over the electronic medium contains the following steps:
allowing user to express his liking or disliking of an item by clicking on appropriate buttons (liking button or disliking button) on a product;
displaying user various attributes of a liked item and allowing him to select the attributes that he liked about the item, and storing these preferences in the profile for the user as liked attributes of the item;
displaying user various attributes of a disliked item and allowing him to select the attributes that he disliked about the item, and storing these preferences in the profile for the user as the disliked attributes of the item;
including the liked attributes in the future searches for similar items such that the items which have liked attributes show up in the top results; and
including the disliked attributes in the search for similar items such that the items which have disliked attributes show up last.

This system also allows customers to shop for their friends. There are two ways user can shop for their friend. The system needs friend's personal information to enable this service. The customer can provide friend's customer personal information to the system in two ways:
First they can input the personal information about their friend themselves.
If their friend also has an account with this system, they can send the friend a personal information sharing request. When the friend approves the sharing of personal information, they can start shopping for him. For security reason, the customer will not be able to view or edit his friend's shared personal information.

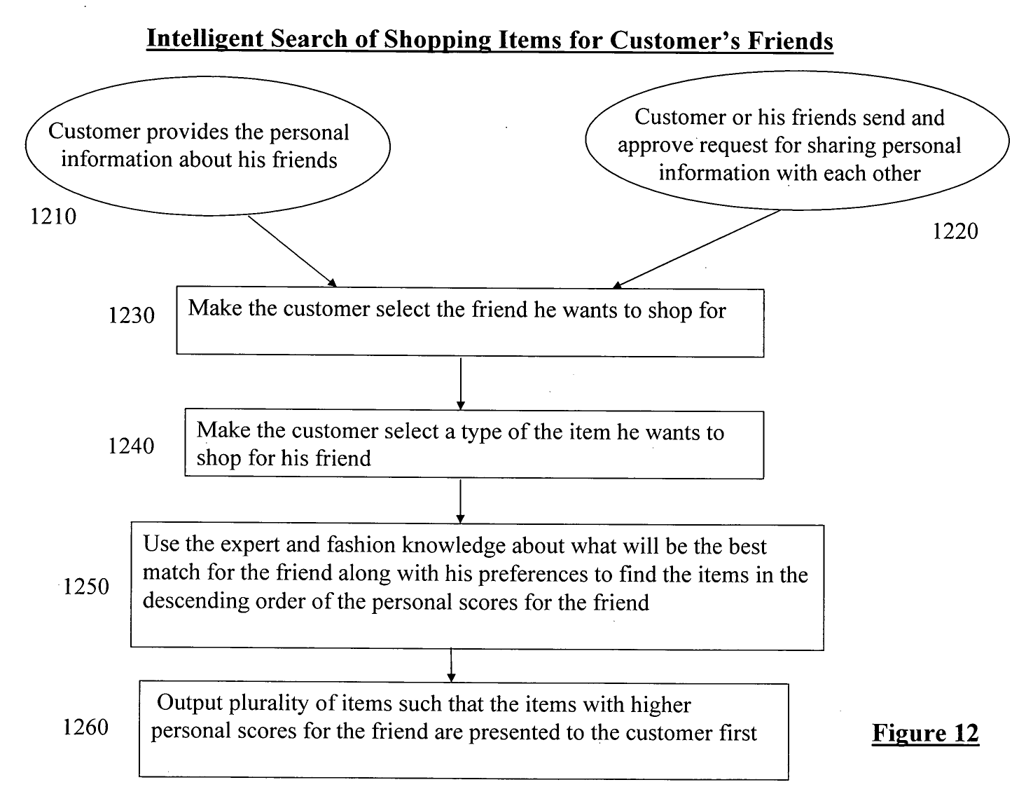

To shop for a friend, the user selects the friend. The selection of friend allows the system to retrieve personal information for friend. The next step for the customer to select the item he wants to shop. When the customer selects the item, the system uses the expert and fashion knowledge about what will be the best match for the friend along with his preferences to find the items in the descending order of the personal scores for the friend. The retrieved items are presented to the customer in the descending order of friend's personal score. FIG. 12 illustrates the flowchart of the method for intelligent search of shopping items for customer's friends.

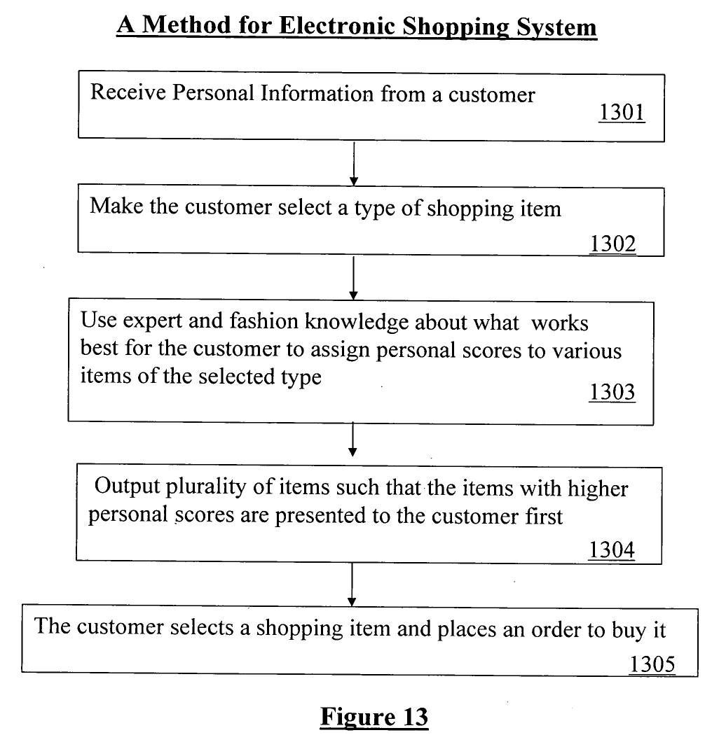

FIG. 13 presents the flowchart of the method an electronic shopping system. This method is the extension of the method for shopping search system presented in FIG. 1. In addition to the search of a shopping item to maximize his utility and satisfaction, this method includes one additional step that is to select an item from the search results and place an order to buy it.

The foregoing is merely illustrative of the principles of this invention and various modifications can be made by those skilled in the art without departing from the scope and spirit of the invention.

What is claimed is:

1. A method of an electronic shopping search that helps a customer search and shop items which match best for him/her using a programmed computer, cell phone, CD-ROM, television, Internet or any other electronic medium, comprising:
receiving personal information from a customer;
receiving item type to shop from the customer;
using the expert and fashion knowledge about what will be the best match for the customer along with his preferences to find the items in the descending order of the personal scores for the customer; and
outputting plurality of items from the database of items such that the items with the higher personal scores are retrieved and displayed before the items with the lower personal scores.

2. The method defined in claim 1, wherein the shopping search system helps customers search and shop items over the Internet, the method further comprising using fashion knowledge about what looks good from fashion point of view for customers with different body characteristics to search fashion items such that the items which will good for the customers are outputted first.

3. The method defined in claim 1, wherein the shopping search system helps customers search and shop items over the Internet, the method further comprising:
including fashion knowledge about what looks good (physical attractiveness) for different body types and personal styles of customers, and
making physical attractiveness as one of the key component for the personal score of fashion items such that the items which will look good from fashion point of view for the customer will get higher scores.

4. The method defined in claim 1, wherein the shopping search system helps customers search and shop items over the Internet, the method further comprising:
using fashion trends knowledge about people of various personal styles to find what will be fashionable items for the customer; and
continuously updating the fashion trend knowledge as it changes with time.

5. The method defined in claim 1, wherein the shopping search system helps customers search and shop items over the Internet, the method further comprising:
including knowledge about fashion trends for different personal styles of customers;
making fashion trend as one of the key component of the personal score for the fashion items such that the items which are in trend will get higher scores for the customer who care for such trends; and
continuously updating the fashion trend knowledge rules as this information changes with time.

6. The method defined in claim 1, wherein the shopping search system helps customers search and shop items over the Internet, the method further comprising using expert knowledge about the benefits, quality, and side effects of the item materials, ingredient, and components for people with different body characteristics and problems to find the items with maximum benefits, higher quality and low side effect for the customer.

7. The method defined in claim 1, wherein the shopping search system helps customers search and shop items over the Internet, the method further comprising:
including expert knowledge rules in the knowledge store about the benefits, quality, and side effects of the item materials and ingredient for people with different body characteristics and problems; and
making the benefits, quality, and side effects of the item ingredients and materials as one of the key component for the personal score of search items such that the items with maximum benefits, higher quality, and fewer side effects will get higher scores

8. The method defined in claim 1, wherein the shopping search system helps customers search and shop items over the Internet, the method further comprising using market price of the components used by an item to estimate the total market value of the item and helping the customer find items where the price of the item is lower or similar to the market price of the item.

9. The method defined in claim 1, wherein the shopping search system helps customers search and shop items over the Internet, the method further comprising:
including market price of ingredients and components of shopping items;
including expert knowledge about evaluating the market price of items using the market price of its components such as diamonds and gems; and
making the value of items (price vs market value) as one of the key component for the personal score of search items such that the items whose price is lower or same as the market value of items get higher scores.

10. The method defined in claim 1, wherein the shopping search system helps customers search and shop items over the Internet, the method further comprising including customer ratings, editorial ratings, and expert ratings as components of the personal score for the customer such that the items with higher ratings get higher scores

11. The method defined in claim 1, wherein the shopping search system helps customers search and shop items over the Internet, the method further comprising including knowledge about the quality, performance, and other attributes of brands for shopping items and using this knowledge to search items which have the best match for the customer

12. The method defined in claim 1, wherein the shopping search system helps customers search and shop items over the Internet, the method further comprising including reliability and quality of products based on the tests done by certified authorities and experience of real users into the personal score for items for the customer such that the items with the higher reliability and quality get higher scores

13. The method defined in claim 1, wherein the shopping search system continuously learns customer preferences, the method further comprising:
allowing user to select likeness or dislike-ness of an item from search result;
showing user various attributes of a liked item and allowing him to select the attributes that he liked about the item, and storing these preferences in the profile for the user as liked attributes of the item;
showing user various attributes of a disliked item and allowing him to select the attributes that he disliked about the item, and storing these preferences in the profile for the user as the disliked attributes of the item;

14. The method defined in claim 1, wherein the shopping search system continuously learns customer preferences and assigns a personal score to items, the method further comprising:
including user preferences in the personal score for items such that the items which meet user preference criteria get higher scores;
including the liked attributes in the personal score such that the items which have liked attributes get higher scores;
including the disliked attributes in the personal score such that the items which have disliked attributes get very low scores;

15. The method defined in claim 1, wherein the shopping search system shows the items with the higher utility first for the customer; the method further comprising:
selecting the most suitable matching item types for a given item;
including matching knowledge rules for these item types such that the selected item has good match with these item types;
making the matching analysis as one of the key component for the personal score of the matching search items such that the items with higher matching attributes will get higher scores
displaying matching items with high personal score along with the selected search item such that the personal score of matching items includes matching analysis as well as other analysis

16. The method defined in claim 1, wherein the shopping search system shows the items with the higher utility first for the customer, the method further comprising:
using knowledge store to find the attributes which are good for the customer and their degree of goodness;
using knowledge store to find attributes which are bad for the customer and their degree of badness;
building ranked combination of attributes such that the combination with better match for the customer are ranked higher
using the ranked combinations of attributes to retrieve items from the database such that the item with the higher ranked combinations of attributes are retrieved before the items with lower ranked combinations of attributes
sorting retrieved items in the descending order of personal score

17. A method of continuously learning customer preferences and using them to improve the quality of search results of a shopping search system that helps customers search and shop items over the Internet using a programmed computer, CD-ROM, television, Internet or other electronic medium such as video, comprising:
allowing user to select likeness or dislike-ness of an item from search results displayed by the shopping search system;
displaying user various attributes of a liked item and allowing him to select the attributes that he liked about the item, and storing these preferences in the profile for the user as liked attributes of the item;
displaying user various attributes of a disliked item and allowing him to select the attributes that he disliked about the item, and storing these preferences in the profile for the user as the disliked attributes of the item;
including the liked attributes in the future searches for similar items such that the items which have liked attributes show up in the top results;
including the disliked attributes in the search for similar items such that the items which have disliked attributes show up last.

18. A method of Internet shopping system that helps a customer shop items which are best match for him/her using a programmed computer, cell phone, CD-ROM, television, Internet or any other electronic medium, comprising:
receiving personal information from a customer;
receiving item type to shop from the customer;
using the expert and fashion knowledge about what will be the best match for the customer along with his preferences to find the items in the descending order of the personal scores for the customer;
outputting plurality of items from the database of items such that the items with the higher personal scores are retrieved and displayed before the items with the lower personal scores; and
receiving item selection and order processing information from the customer;
processing the order information for the selected item

19. A method of an electronic shopping search that helps a customer search and shop items which match best for his friend using a programmed computer, cell phone, CD-ROM, television, Internet or any other electronic medium, comprising:
receiving personal information from a customer about his friend;
receiving item type to shop from the customer;
using the expert and fashion knowledge about what will be the best match for the friend along with his preferences to find the items in the descending order of the personal scores for the customer; and
outputting plurality of items from the database of items such that the items with the higher personal scores are retrieved and displayed before the items with the lower personal scores.

20. The method defined in claim 19, wherein the shopping search system helps customers search and shop items over the Internet for his friend, the method further comprising:
sending request to share personal information with a friend for the purpose of shopping for the friend; and
the friend approving the request to share personal information; and
using the shared personal information to shop for the friend

21. The method defined in claim 19, wherein the shopping search system helps customers search and shop items over the Internet for his friend, the method further comprising:
receiving request to share personal information from a friend for the purpose of shopping for the friend; and
approving the friend's request to share personal information; and
using the shared personal information to shop for the friend
